(19) United States
(12) Patent Application Publication
(10) Pub. No.: US 2017/0285979 A1
(43) Pub. Date: Oct. 5, 2017

(54) STORAGE MANAGEMENT SYSTEM AND METHOD

(71) Applicant: EMC Corporation, Hopkinton, MA (US)

(72) Inventors: Bhawani Singh, Bangalore (IN); Anurag Sushi I Chandra, Bangalore (IN); Mani Bhushan Jangde, Bangalore (IN); Prem Agarwal, Bangalore (IN)

(21) Appl. No.: 15/183,413

(22) Filed: Jun. 15, 2016

(30) Foreign Application Priority Data
Mar. 29, 2016 (IN) 201641010710

(51) Int. Cl. G06F 3/06

(52) U.S. Cl. CPC G06F 3/0619; G06F 3/0689; G06F 3/0665; G06F 3/0659

(57) ABSTRACT

A method, computer program product, and computing system for receiving, on a virtualized storage platform from a virtualized computing platform, one or more XCOPY commands. Each of the one or more XCOPY commands concerns the copying of data from a first storage object. The virtualized storage platform is enabled to control the execution of the one or more XCOPY commands.

### RELATED APPLICATION

This application claims the benefit of Indian Application No. 201641010710, filed on 29 Mar. 2016, entitled “Storage Management System and Method”, the contents of which are incorporated herein by reference.

### TECHNICAL FIELD

This disclosure relates to storage systems and, more particularly, to RAID-based storage systems.

### BACKGROUND

Storing and safeguarding electronic content is of paramount importance in modern business. Accordingly, various methodologies may be employed to protect such electronic content. Examples of such methodologies may include the virtualization of computing systems and the virtualization of storage systems. When utilizing such virtualization systems, portions of data may be “cloned” so that e.g., other users/systems may access the copy of existing data (i.e., the cloned data). Unfortunately and when cloning data, inefficiencies may be experienced.

### SUMMARY OF DISCLOSURE

In one implementation, a computer-implemented method, which is executed on a computing device, includes receiving, on a virtualized storage platform from a virtualized computing platform, one or more XCOPY commands. Each of the one or more XCOPY commands concerns the copying of data from a first storage object. The virtualized storage platform is enabled to control the execution of the one or more XCOPY commands.

One or more of the following features may be included. The one or more XCOPY commands may be executed on the virtualized storage platform. Enabling the virtualized storage platform to control the execution of the one or more XCOPY commands may include sequencing the one or more XCOPY commands. Sequencing the one or more XCOPY commands may include one or more of: manually sequencing the one or more XCOPY commands based upon user input; and automatically sequencing the one or more XCOPY commands based upon priority. Enabling the virtualized storage platform to control the execution of the one or more XCOPY commands may include providing statistical data concerning the execution of the one or more XCOPY commands. Enabling the virtualized storage platform to control the execution of the one or more XCOPY commands may include one or more of: enabling the starting of the one or more XCOPY commands; enabling the stopping of the one or more XCOPY commands; enabling the pausing of the one or more XCOPY commands; and enabling the ending of the one or more XCOPY commands. The first storage object may be a first LUN.

In another implementation, a computer program product resides on a computer readable medium and has a plurality of instructions stored on it. When executed by a processor, the instructions cause the processor to perform operations including receiving, on a virtualized storage platform from a virtualized computing platform, one or more XCOPY commands. Each of the one or more XCOPY commands concerns the copying of data from a first storage object. The virtualized storage platform is enabled to control the execution of the one or more XCOPY commands.

One or more of the following features may be included. The one or more XCOPY commands may be executed on the virtualized storage platform. Enabling the virtualized storage platform to control the execution of the one or more XCOPY commands may include sequencing the one or more XCOPY commands. Sequencing the one or more XCOPY commands may include one or more of: manually sequencing the one or more XCOPY commands based upon user input; and automatically sequencing the one or more XCOPY commands based upon priority. Enabling the virtualized storage platform to control the execution of the one or more XCOPY commands may include providing statistical data concerning the execution of the one or more XCOPY commands. Enabling the virtualized storage platform to control the execution of the one or more XCOPY commands may include one or more of: enabling the starting of the one or more XCOPY commands; enabling the stopping of the one or more XCOPY commands; enabling the pausing of the one or more XCOPY commands; and enabling the ending of the one or more XCOPY commands. The first storage object may be a first LUN.

In another implementation, a computing system including a processor and memory is configured to perform operations including receiving, on a virtualized storage platform from a virtualized computing platform, one or more XCOPY commands. Each of the one or more XCOPY commands concerns the copying of data from a first storage object. The virtualized storage platform is enabled to control the execution of the one or more XCOPY commands.

One or more of the following features may be included. The one or more XCOPY commands may be executed on the virtualized storage platform. Enabling the virtualized storage platform to control the execution of the one or more XCOPY commands may include sequencing the one or more XCOPY commands. Sequencing the one or more XCOPY commands may include one or more of: manually sequencing the one or more XCOPY commands based upon user input; and automatically sequencing the one or more XCOPY commands based upon priority. Enabling the virtualized storage platform to control the execution of the one or more XCOPY commands may include providing statistical data concerning the execution of the one or more XCOPY commands. Enabling the virtualized storage platform to control the execution of the one or more XCOPY commands may include one or more of: enabling the starting of the one or more XCOPY commands; enabling the stopping of the one or more XCOPY commands; enabling the pausing of the one or more XCOPY commands; and enabling the ending of the one or more XCOPY commands. The first storage object may be a first LUN.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a storage system and a storage management process coupled to a distributed computing network;

FIG. 2 is a diagrammatic view of the storage system of FIG. 1;

FIG. 3 is a diagrammatic view of another embodiment of the storage system of FIG. 1;

FIG. 4 is a flow chart of the storage management process of FIG. 1; and

FIG. 5 is a diagrammatic view of a window rendered by the storage management process of FIG. 4.

Like reference symbols in the various drawings indicate like elements.

### DETAILED DESCRIPTION OF THE PREFERRED EMBODIMENTS

### System Overview:

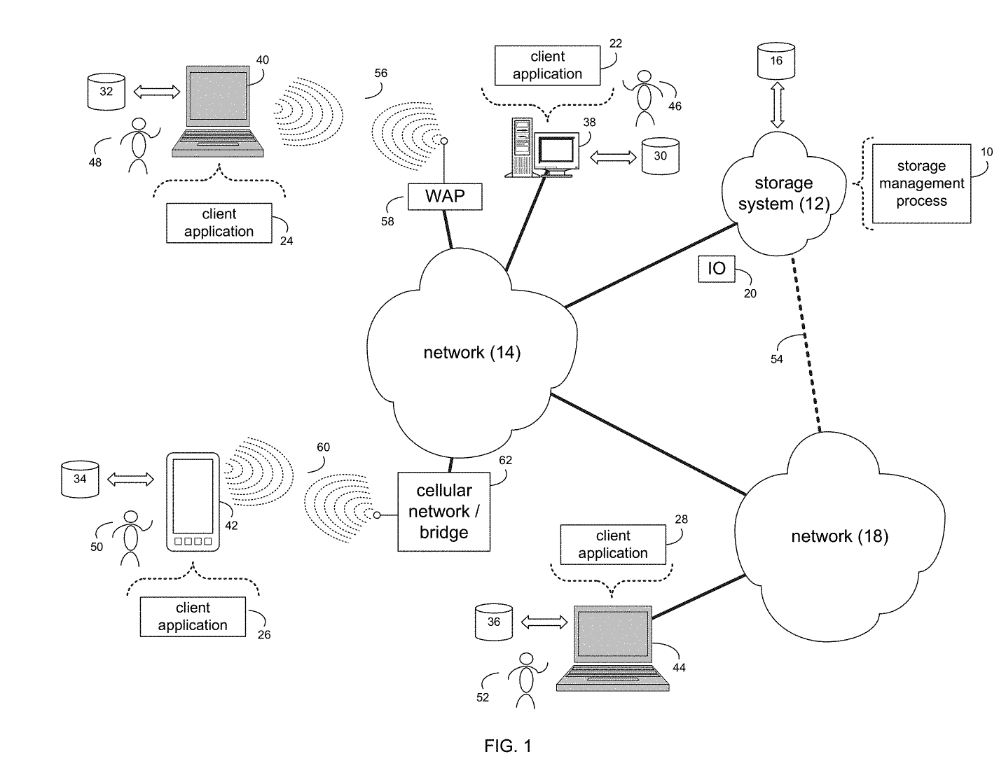

Referring to FIG. 1, there is shown storage management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft Windows Server™; Redhat Linux™, Unix, or a custom operating system, for example.

The instruction sets and subroutines of storage management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices (e.g., client electronic devices 38, 40, 42, 44) may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft Windows™, Apple Macintosh™, Redhat Linux™, or a custom operating system.

For illustrative purposes, storage system 12 will be described as being a network-based storage system that includes a plurality of backend storage devices. However, this is for illustrative purposes only and is not intended to be a limitation of this disclosure, as other configurations are possible and are considered to be within the scope of this disclosure.

### Data Storage System:

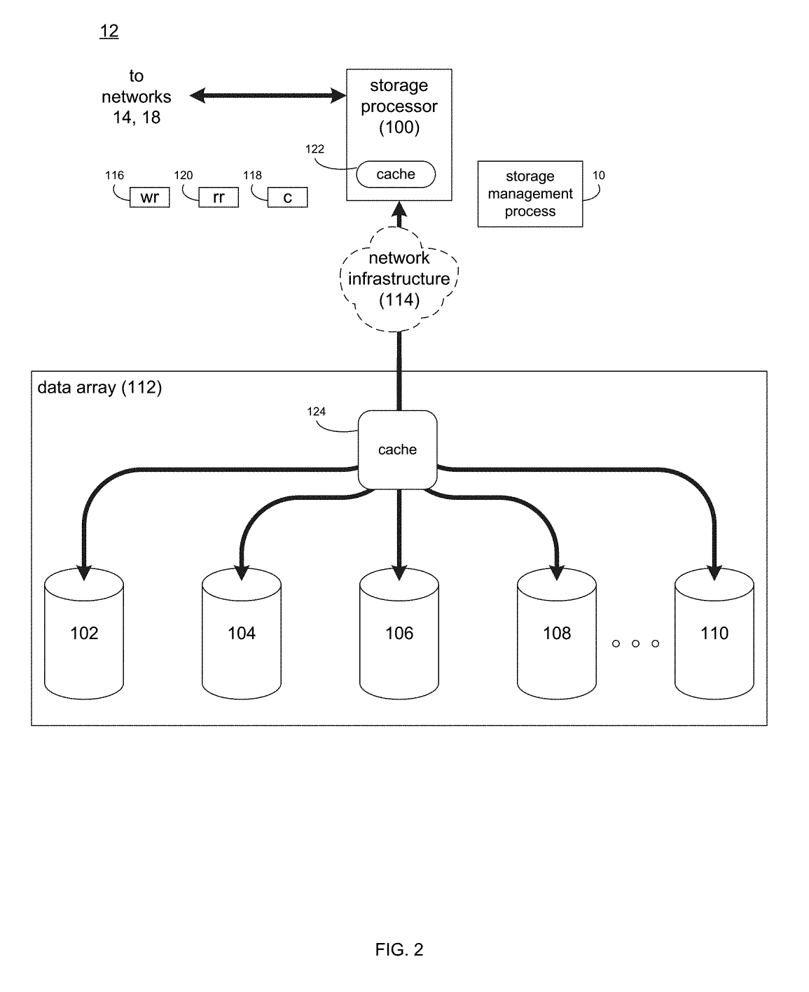

Referring also to FIG. 2, there is shown a general implementation of storage system 12. In this general implementation, data storage system 12 may include storage processor 100 and a plurality of storage targets (e.g. storage targets 102, 104, 106, 108, 110). Storage targets 102, 104, 106, 108, 110 may be configured to provide various levels of performance and/or high availability. For example, one or more of storage targets 102, 104, 106, 108, 110 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108, 110 may be configured as a RAID 1 array, in which data is mirrored between storage targets. By mirroring data between storage targets, a level of high availability is achieved as multiple copies of the data are stored within storage system 12.

While storage targets 102, 104, 106, 108, 110 are discussed above as being configured in a RAID 0 or RAID 1 array, this is for illustrative purposes only and is not intended to be a limitation of this disclosure, as other configurations are possible. For example, storage targets 102, 104, 106, 108, 110 may be configured as a RAID 3, RAID 4, RAID 5, RAID 6 or RAID 7 array.

While in this particular example, storage system 12 is shown to include five storage targets (e.g. storage targets 102, 104, 106, 108, 110), this is for illustrative purposes only and is not intended to be a limitation of this disclosure. Specifically, the actual number of storage targets may be increased or decreased depending upon e.g. the level of redundancy/performance/capacity required.

One or more of storage targets 102, 104, 106, 108, 110 may be configured to store coded data, wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage device.

Examples of storage targets 102, 104, 106, 108, 110 may include one or more electro-mechanical hard disk drives and/or solid-state/flash devices, wherein a combination of storage targets 102, 104, 106, 108, 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108, 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108, 110 may be a RAID device and/or computer-based hard disk drives. Further still, one or more of storage targets 102, 104, 106, 108, 110 may be a SAN.

In the event that storage system 12 is configured as a SAN, the various components of storage system 12 (e.g. storage processor 100, storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of storage management process 10. The instruction sets and subroutines of storage management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (i.e. a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, 110.

As discussed above, the instruction sets and subroutines of storage management process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of storage management process 10 may be executed by one or more processors (not shown) and one or more memory architectures (not shown) included within data array 112.

### The Storage Management Process:

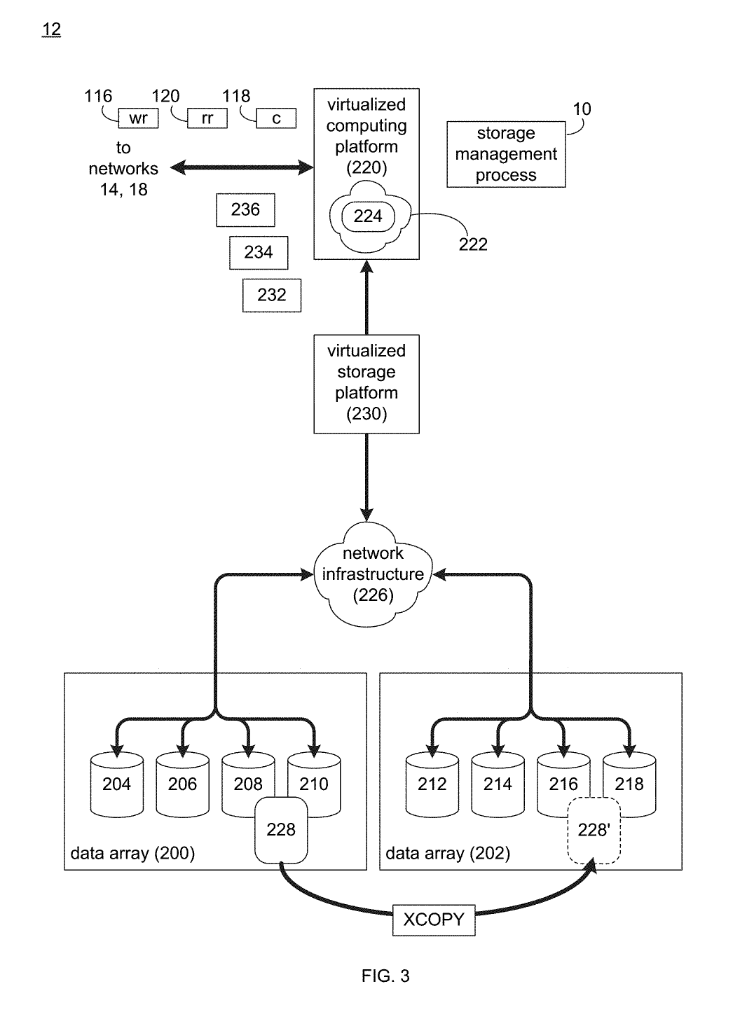

Referring also to FIG. 3, there is shown another implementation of storage system 12 that includes two separate and distinct data arrays (e.g., data arrays 200, 202). For illustrative purposes only, the first data array (e.g., data array 200) is shown to include four storage targets (e.g., storage targets 204, 206, 208, 210). Further, the second data array (e.g., data array 202) is shown to include four storage targets (e.g., storage targets 212, 214, 216, 218).

In this implementation, virtualized computing platform 220 performs the functions of storage processor 100 (See FIG. 1). An example of virtualized computing platform 220 may include but is not limited to a ESX system offered by the EMC Corporation of Hopkinton, Mass. As is known in the art, virtualized computing platform 220 may execute of one or more virtual machine operating environments (e.g., virtual machine operating environment 222). An example of virtual machine operating environment 222 may include but is not limited to a hypervisor, which is an instantiation of an operating system that may allow for one or more virtual machines (e.g., virtual machine 224) to operate within a single physical device.

Data array 200, data array 202 and virtualized computing platform 220 may be coupled using network infrastructure 226, examples of which may include but are not limited to an Ethernet (e.g., Layer 2 or Layer 3) network, a fiber channel network, an InfiniBand network, or any other circuit switched/packet switched network.

For the following example, assume that data arrays 200, 202 may include functionality that may be configured to define and expose one or more logical units that users of virtualized computing platform 220 may use and access to store data. Specifically, assume that data array 200 defines and exposes LUN 228 that may allow for the storage of data within data array 200.

As discussed above and for this example, storage system 12 is shown to include two separate and distinct data arrays (e.g., data arrays 200, 202). Accordingly, storage system 12 may further include virtualization storage platform appliances (e.g., virtualization storage platform 230) that may allow for seamless access to one or both of data arrays 200, 202 and the various data portions contained/defined therein (e.g., LUN 228). An example of virtual storage platform 230 may include but is not limited to a VPLEX system produced by the EMC Corporation of Hopkinton, Mass. As is known in the art, virtualized storage platform 230 may implement a distributed “virtualization” layer within and across geographically disparate data arrays (e.g., data arrays 200, 202), storage area networks and/or data centers, thus allowing multiple, discrete storage entities to appear as one common entity.

Assume for the following example that LUN 228 needs to be “cloned” (i.e., copied) from e.g., data array 200 to data array 202, which may be required for various reasons (e.g., maintenance of data array 200, one or more components of data array 200 being decommissioned, one or more components of data array 200 being sold/coming off lease, and/or the general need for a second copy of LUN 228).

While, in this example, the data portion to be “cloned” is a LUN, this is for illustrative purposes only and is not intended to be a limitation of this disclosure, as other configurations are possible. For example, the data portion to be “cloned” may be smaller (e.g., a database file) or may be larger (e.g., the entire content of data array 200).

Continuing with the above-stated example, assume that LUN 228 is going to be “cloned” to create a copy of LUN 228 (namely LUN 228′). While in this example, LUN 228 is being “cloned” onto a different data array (e.g., data array 202), this is for illustrative purposes only and is not intended to be a limitation of this disclosure. For example, LUN 228 may be “cloned” onto the same data array (e.g., data array 200). Concerning the “cloning” of LUN 228 to create the copy of LUN 228 (namely LUN 228′), this “cloning” operation may be accomplished via an XCOPY procedure.

As is known in the art, the XCOPY (which stands for eXtended COPY) is used within various operating systems and allows for the copying of multiple files (or entire directory trees) from one directory to another, either locally or across a network infrastructure.

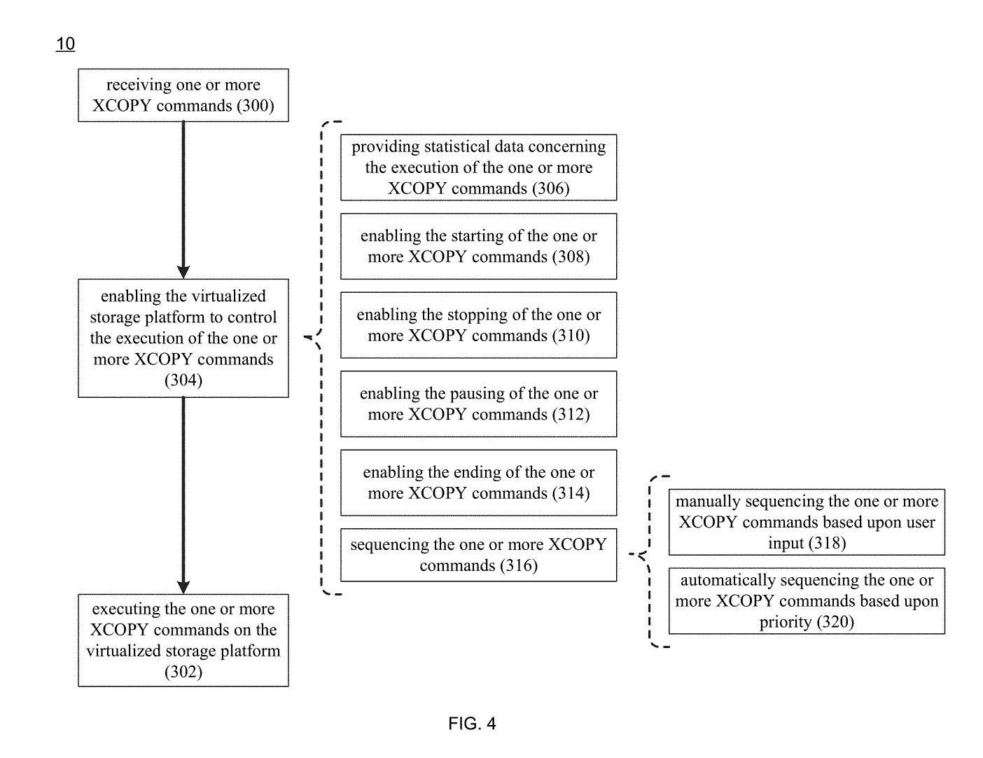

Referring also to FIG. 4, storage management process 10 may receive 300, on a virtualized storage platform (e.g., virtual storage platform 230) from a virtualized computing platform (e.g., virtualized computing platform 220), one or more XCOPY commands (e.g., XCOPY command 232). Assume that each of these XCOPY commands (e.g., XCOPY command 232) concerns the copying of data from a first storage object. Continuing with the above-stated example, this first storage object is a first LUN (e.g., LUN 228). Further, assume that XCOPY command 232 further defines the target LUN as LUN 228′, which is to be located on data array 202.

Upon receiving 300 XCOPY command 232, storage management process 10 may execute 302 the one or more XCOPY commands (e.g., XCOPY command 232) on virtualized storage platform 230, which may effectuate the “cloning” of LUN 228 from data array 200 onto data array 202 to form LUN 228′. Additionally, storage management process 10 may enable 304 virtualized storage platform 230 to control the execution of the one or more XCOPY commands (e.g., XCOPY command 232). Accordingly, when storage management process 10 receives 300 (on virtual storage platform 230) XCOPY command 232 from virtualized computing platform 220, the user (e.g., user 46, user 48, user 50 or user 52) who initiated XCOPY command 232 may still be able to control the execution of XCOPY command 232 even though XCOPY command 232 was handed off from virtualized computing platform 220 to virtualized storage platform 230.

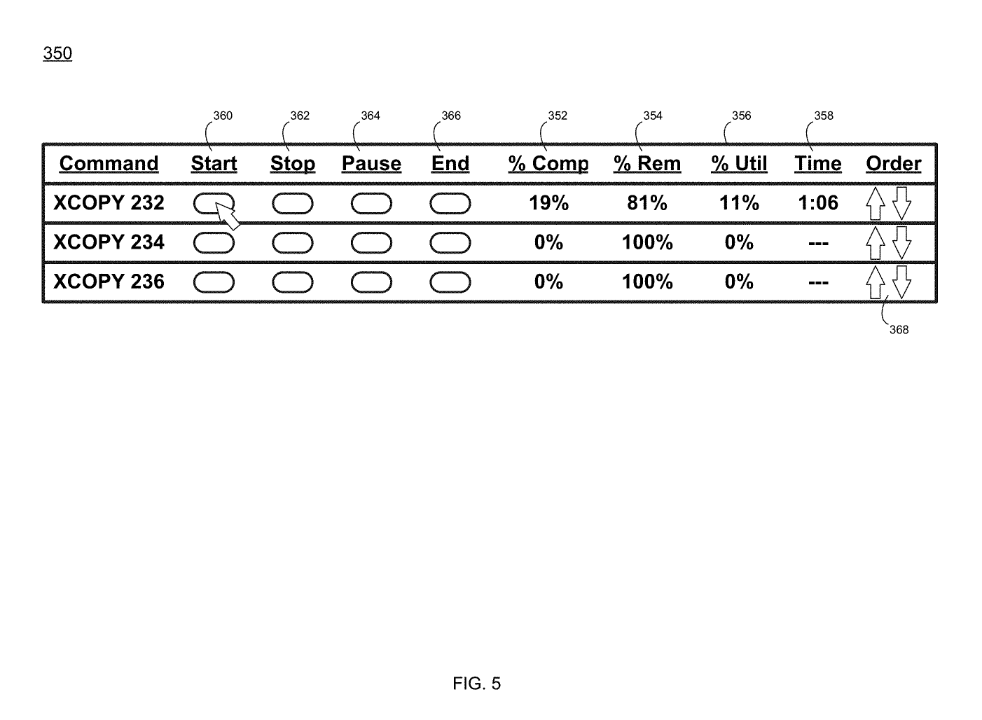

When enabling 304 the virtualized storage platform to control the execution of the one or more XCOPY commands, storage management process 10 may provide 306 statistical data concerning the execution of the one or more XCOPY commands. For example and referring also to FIG. 5, storage management process 10 may render status & control window 350 that may provide the user (e.g., user 46, user 48, user 50 or user 52) with statistical information (e.g., % Complete 352; % Remaining 354; Bandwidth Utilization 356; and Time Taken 358). Status & control window 350 may be rendered on the client electronic device being used by the user (e.g., user 46, user 48, user 50 or user 52).

Additionally and when enabling 304 virtualized storage platform 230 to control the execution of the one or more XCOPY commands (e.g., XCOPY command 232), storage management process 10 may enable 308 the starting of the one or more XCOPY commands (e.g., XCOPY command 232); may enable 310 the stopping of the one or more XCOPY commands (e.g., XCOPY command 232); may enable 312 the pausing of the one or more XCOPY commands; and enable 314 the ending of the one or more XCOPY commands.

For example, status & control window 350 that may enable the user (e.g., user 46, user 48, user 50 or user 52) to start, stop, pause and end (in this example) XCOPY command 232. Status & control window 350 may be rendered on the client electronic device being used by the user (e.g., user 46, user 48, user 50 or user 52) and the various options (e.g., Start 360, Stop 362, Pause 364, End 368) may be selected via an onscreen pointer (e.g., controllable by a touch command or a mouse; not shown).

As discussed above, storage management process 10 may receive 300 one or more XCOPY commands (e.g., XCOPY command 232). Accordingly, assume that XCOPY commands 234, 236 are received 300 in addition to XCOPY command 232. In such a situation, storage management process may control the order in which (in this example) these three XCOPY commands (e.g., XCOPY commands 232, 234, 236) are executed. Specifically and when enabling 304 virtualized storage platform 230 to control the execution of the one or more XCOPY commands (e.g., XCOPY commands 232, 234, 236), storage management process 10 may sequence 316 these XCOPY commands (e.g., XCOPY commands 232, 234, 236).

Accordingly and when rendering status & control window 350, storage management process 10 may include statistical information and control options for the additional XCOPY commands (e.g., XCOPY commands 234, 236). When sequencing 316 the one or more XCOPY commands (e.g., XCOPY commands 232, 234, 236), storage management process 10 may manually sequence 318 the one or more XCOPY commands (e.g., XCOPY commands 232, 234, 236) based upon user input and/or may automatically sequence 320 the one or more XCOPY commands (e.g., XCOPY commands 232, 234, 236) based upon priority.

For example, status & control window 350 may be configured to allow a user to manually sequence the individual XCOPY commands ((e.g., XCOPY commands 232, 234, 236) via e.g., a pair of up & down arrows (e.g., up & down arrows 368), wherein the user (e.g., user 46, user 48, user 50 or user 52) may use up & down arrows 368 to prioritize/deprioritize the individual XCOPY commands. Therefore, if e.g., XCOPY command 234 is high priority, the user (e.g., user 46, user 48, user 50 or user 52) may select the up arrow associated with XCOPY command 234 to move XCOPY command 234 higher in the queue of XCOPY commands to be executed. Conversely, if e.g., XCOPY command 232 is consuming too many resources and is low priority, the user (e.g., user 46, user 48, user 50 or user 52) may select the down arrow associated with XCOPY command 232 to move XCOPY command 232 lower in the queue of XCOPY commands to be executed.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving, on a virtualized storage platform from a virtualized computing platform, one or more XCOPY commands, wherein each of the one or more XCOPY commands concerns the copying of data from a first storage object; and
enabling the virtualized storage platform to control the execution of the one or more XCOPY commands.

2. The computer-implemented method of claim 1 further comprising:
executing the one or more XCOPY commands on the virtualized storage platform.

3. The computer-implemented method of claim 1 wherein enabling the virtualized storage platform to control the execution of the one or more XCOPY commands includes:
sequencing the one or more XCOPY commands.

4. The computer-implemented method of claim 3 wherein sequencing the one or more XCOPY commands includes one or more of:
manually sequencing the one or more XCOPY commands based upon user input; and
automatically sequencing the one or more XCOPY commands based upon priority.

5. The computer-implemented method of claim 1 wherein enabling the virtualized storage platform to control the execution of the one or more XCOPY commands includes:
providing statistical data concerning the execution of the one or more XCOPY commands.

6. The computer-implemented method of claim 1 wherein enabling the virtualized storage platform to control the execution of the one or more XCOPY commands includes one or more of:
enabling the starting of the one or more XCOPY commands;
enabling the stopping of the one or more XCOPY commands;
enabling the pausing of the one or more XCOPY commands; and
enabling the ending of the one or more XCOPY commands.

7. The computer-implemented method of claim 1 wherein the first storage object is a first LUN.

8. A computer program product residing on a computer readable medium having a plurality of instructions stored thereon which, when executed by a processor, cause the processor to perform operations comprising:
receiving, on a virtualized storage platform from a virtualized computing platform, one or more XCOPY commands, wherein each of the one or more XCOPY commands concerns the copying of data from a first storage object; and
enabling the virtualized storage platform to control the execution of the one or more XCOPY commands.

9. The computer-implemented method of claim 8 further comprising instructions for:
executing the one or more XCOPY commands on the virtualized storage platform.

10. The computer program product of claim 8 wherein enabling the virtualized storage platform to control the execution of the one or more XCOPY commands includes:
sequencing the one or more XCOPY commands.

11. The computer program product of claim 10 wherein sequencing the one or more XCOPY commands includes one or more of:
manually sequencing the one or more XCOPY commands based upon user input; and
automatically sequencing the one or more XCOPY commands based upon priority.

12. The computer program product of claim 8 wherein enabling the virtualized storage platform to control the execution of the one or more XCOPY commands includes:
providing statistical data concerning the execution of the one or more XCOPY commands.

13. The computer program product of claim 8 wherein enabling the virtualized storage platform to control the execution of the one or more XCOPY commands includes one or more of:
enabling the starting of the one or more XCOPY commands;
enabling the stopping of the one or more XCOPY commands;
enabling the pausing of the one or more XCOPY commands; and
enabling the ending of the one or more XCOPY commands.

14. The computer program product of claim 8 wherein the first storage object is a first LUN.

15. A computing system including a processor and memory configured to perform operations comprising:
receiving, on a virtualized storage platform from a virtualized computing platform, one or more XCOPY commands, wherein each of the one or more XCOPY commands concerns the copying of data from a first storage object; and
enabling the virtualized storage platform to control the execution of the one or more XCOPY commands.

16. The computing system of claim 15 further configured to perform operations comprising:
executing the one or more XCOPY commands on the virtualized storage platform.

17. The computing system of claim 15 wherein enabling the virtualized storage platform to control the execution of the one or more XCOPY commands includes:
sequencing the one or more XCOPY commands.

18. The computing system of claim 17 wherein sequencing the one or more XCOPY commands includes one or more of:
manually sequencing the one or more XCOPY commands based upon user input; and
automatically sequencing the one or more XCOPY commands based upon priority.

19. The computing system of claim 15 wherein enabling the virtualized storage platform to control the execution of the one or more XCOPY commands includes:
providing statistical data concerning the execution of the one or more XCOPY commands.

20. The computing system of claim 15 wherein enabling the virtualized storage platform to control the execution of the one or more XCOPY commands includes one or more of:
enabling the starting of the one or more XCOPY commands;
enabling the stopping of the one or more XCOPY commands;
enabling the pausing of the one or more XCOPY commands; and
enabling the ending of the one or more XCOPY commands.

21. The computing system of claim 15 wherein the first storage object is a first LUN.
